(19) United States
(12) Patent Application Publication
(10) Pub. No.: US 2023/0332605 A1
(43) Pub. Date: Oct. 19, 2023

(54) Pumping System and Method of Use Thereof

(71) Applicants: William N TALLY, Farmington Hills, MI (US); Renew Health Ltd, Athlone (IE)

(72) Inventors: William Tally, Milford, MI (US); Jeffrey Drulia, Royal Oak, MI (US); Jeffrey Dupuis, Royal Oak, MI (US); Michael Kovalcik, Farmington Hills, MI (US); Jack Juni, Royal Oak, MI (US); Alex Ruffolo, Ferndale, MI (US)

(73) Assignee: IDA Business & Technology Park, Garrycastle, Athlone (IE)

(21) Appl. No.: 18/025,710

(22) PCT Filed: Sep. 13, 2021
(86) PCT No.: PCT/US2021/050080

§ 371 Date: Mar. 10, 2023

Related U.S. Application Data
(60) Provisional application No. 63/084,718, filed on Sep. 29, 2020.
(60) Provisional application No. 63/077,960, filed on Sep. 14, 2020.

(51) Int. Cl. F04D 13/14; F04D 29/42; F04D 29/62; F04D 1/06; F04D 15/00; F04D 13/06; B01F 27/191; B01F 25/60

(52) U.S. Cl. CPC F04D 13/14; F04D 29/4293; F04D 29/628; F04D 1/06; F04D 15/0066; F04D 13/06; B01F 27/191; B01F 25/60; B01D 61/10

(57) ABSTRACT

The disclosure relates to pumping systems that may be used to pump fluids in variety of situations where it is important to maintain fluid flow. The systems include at least two pump assemblies. At least one controller, an inlet, an outlet, and a stand.

### INTRODUCTION

A reliable flow of water is essential in many situations. For example, constant water circulation is crucial for residential and commercial buildings, including situations where the building has a water purification system and/or a water storage tank. In some cases, insufficient water flow or excessive water flow may damage water treatment systems, such as damaging membranes used in reverse osmosis devices. In addition, many agricultural applications require a reliable source of water. For example, it is essential to circulate and/or recycle water in greenhouses. In these situations, and others, pumps serve a critical role in maintaining the desired flow of water. Consequently, it is important to have a pumping system that is reliable in different situations, that is easily monitored, and that responds to changing circumstances and requirements for fluid flow.

### SUMMARY

The disclosure relates to pumping systems that help to maintain the flow of fluids, particularly the flow of water. For example, the pumping systems may be used to maintain the flow of water within commercial or residential buildings. The pumping systems of the disclosure may also be used in other situations requiring a reliable flow of water, such as agricultural applications.

The pumping systems of the disclosure include at least two pump assemblies, at least one controller and a stand. The least one controller controls the flow parameters of the least two pump assemblies.

### BRIEF DESCRIPTION OF DRAWINGS

FIG. 1 shows a perspective view of the front of one example of a pumping system according to the disclosure.

FIG. 2 shows a further perspective view of the front of the pumping system of FIG. 1.

FIG. 3 shows a perspective view of the rear a pumping system of FIG. 1.

FIG. 4 shows a further perspective view of the rear of the pumping system of FIG. 1.

FIG. 5 shows an exploded of view of the pumping system of FIG. 1.

FIG. 6 shows a perspective view of an example of two pump assemblies in an enlarged view.

FIG. 7 shows a view of another example of pump assemblies according to the disclosure.

FIG. 8 shows a view of two pump assemblies where one pump assembly is shown in a cross-sectional view, where the interior of one pump assembly is shown.

FIG. 9 shows a cross-sectional view of the pump assemblies of FIG. 8.

FIG. 10a shows a control panel as seen in the front.

FIG. 10b shows a control panel as seen from the rear and partially disassembled.

FIG. 11 shows an enlarged view of pump assemblies from two linked pumping systems.

FIG. 12a shows a view of a bleed valve according to the disclosure.

FIG. 12b shows another view of a bleed valve according to the disclosure.

FIG. 13a shows an example of an impeller according to the disclosure.

FIG. 13b shows an example of a cassette vane according to the disclosure.

FIG. 14 shows a further example of a pumping system according to the disclosure.

FIG. 15 shows an enlarged view of pump assemblies according of FIG. 14.

FIG. 16 shows a further example of a pumping system according to the disclosure.

FIG. 17 shows another view of the pumping system of FIG. 16.

### DETAILED DESCRIPTION

This description provides illustrative examples and is intended to provide an overview or framework for understanding the nature and character of the claims. The accompanying drawings are included to provide illustration and a further understanding of the various aspects and examples and are incorporated in and constitute a part of this specification. The drawings, together with the specification, serve to explain the described and claimed aspects and examples. It is to be understood that the terminology, which has been used herein, is intended to be in the nature of words of description rather than of limitation.

The disclosure relates to systems that may be used to pump fluids. In preferred examples, the disclosed systems pump water. By way of example only, and without limitation, systems of the disclosure may be used to pump water from municipal water sources, may be used to pump water from a well, may be used to pump recycled water, or may be used to pump water that includes dissolved solids. Systems of the disclosure may pump fresh water, salinated water or brackish water.

According to preferred examples, systems of the disclosure are capable of performing redundant pump capabilities. For example, pumping systems of the disclosure may be used as a standalone pumping system or may be used in addition to an existing pump device or devices, such, for example, as a back-up in case of failure or to provide a pressure boost at required times. Further, systems of the disclosure are customizable to meet particular operational needs. For example, one or more systems may be fluidly and electrically linked together and/or may be linked to other components, such as water tanks and/or water treatment systems. For example, pumping systems of the disclosure are compatible with water treatment systems using reverse osmosis membranes.

In general, systems of the disclosure may facilitate transfer of liquids from one site to another. For example, pumping systems of the disclosure may be placed in or adjacent to or within residential or commercial buildings to ensure proper water flow into or through the building. The pumping systems may be used for agricultural applications, such as flowing water to or through a greenhouse.

According to the disclosure, two or more pumping systems may be connected. In some examples, two or systems may be connected in parallel to achieve requirements for a particular use, such as a required output flow of water. In other examples, two or pumping systems may be connected in series or a combination of in parallel and in series.

According to the disclosure, systems may be used to ensure the flow of fluids in numerous situations and according to a number of procedures, depending on requirements. For example, one or more first pumps of the system may operate at full capacity, and one or more second pumps of the system may be in reserve, in case of failure of the first pump. In a second procedure, one or pumps may operate at less than full capacity. For example, a system may have two pumps that operate at about half capacity. In another example, one pump may be used at full capacity to pump water to a target and a second pump used as to continuously recirculate water back to a source.

In general, pumping systems of the disclosure include at least two pump assemblies, at least one control panel where the at least one control panel includes at least one controller, a stand, and piping. In some examples, the pumping system may be enclosed by a case. According to the disclosure, a pump system has at least two pump assemblies, has at least three pump assemblies, or has at least four pump assemblies. Pumps of various designs may be incorporated into the pumping system, depending on requirements.

The system may include one or more fans where the fans are positioned to reduce heat from a pump motor or other sources. The pumping system may include one or more sensors or gauges that monitor water pressure at different points in the system or one or more sensors that monitor water quality, such as total dissolved solids (TDS) at various points in the system. For example, the pump system may reduce water flowing into the pumps if a certain value for IDS is exceeded.

In preferred examples, pump assemblies according to the disclosure include a motor and a mixing component. The mixing component is connected to the motor where the mixing component receives water from a water source. Pumping assemblies according to the disclosure may further include an impeller component connected to the mixing component. The impeller component may include one or more stages where each stage may include impellers. The presence of the impeller component increases energy transfer to the fluid as it flows through the impeller component, thereby increasing flow rate. Pumping assemblies may also include one or more check valves to prevent backflow, Pumping assemblies may also sensors and gauges, Pump assemblies may also include one or more bleed valves.

The control panel incorporates a controller which monitors pump performance and adjusts pump parameters. The system may operate according to algorithms that control pump parameters. For example, the controller may adjust pump speeds when the pump is at the risk of cavitation by adjusting the speed of the pump motor. In preferred examples, the control panel includes a touch screen that will allow a user to adjust pump motor speed, set run times for pumps, adjust pump usage types and other parameters. In preferred examples, the system may be controlled wirelessly, including, for example, using WiFi networks.

A system according to the disclosure includes a stand. The stand may take various forms according to specific requirements, such as the space allocated. For example, pumping systems may present a compact, narrow profile to fit into a particular space. Components of the system are attached to the stand such that the components may stably operate in different environments and situations. In some examples, the stand may be attached or fixed to a surface, such as concrete platform. In other examples; the stand may include wheels, for example, allowing the stand to be mobile.

The system includes piping to connect water source to the pump assembly, to connect the pump assembly to each other, or to connect the pump assembly to an outlet. In general, piping may be formed from materials suitable for a particular application. For example, stainless steel is preferred for use with water. The pumping system further includes O-rings and seals. Diameter of piping may be selected based on requirements.

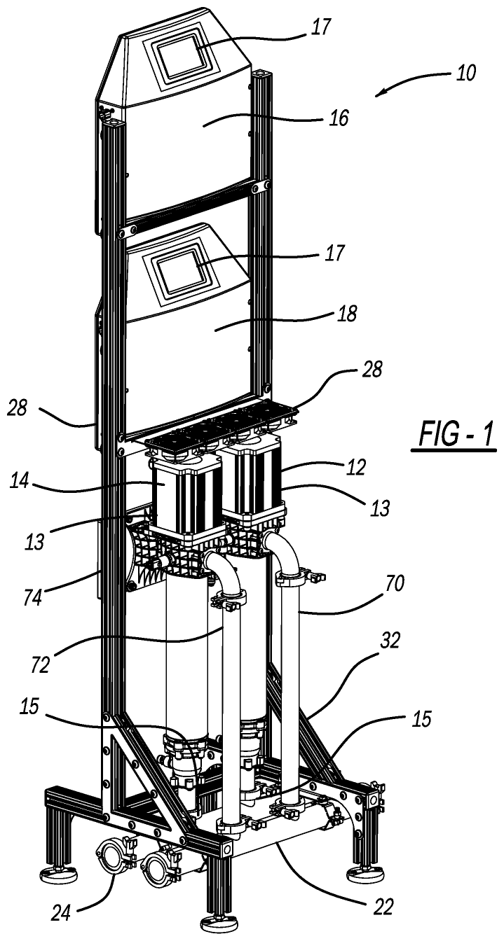

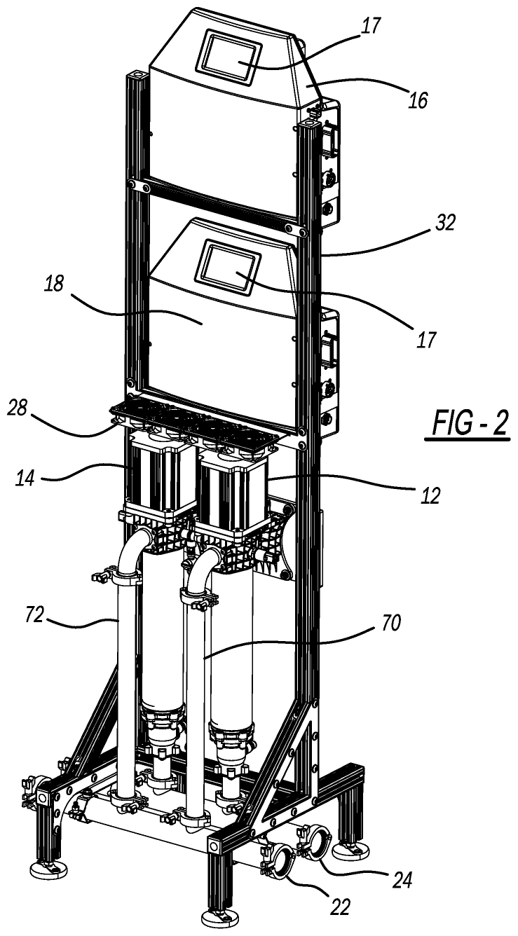

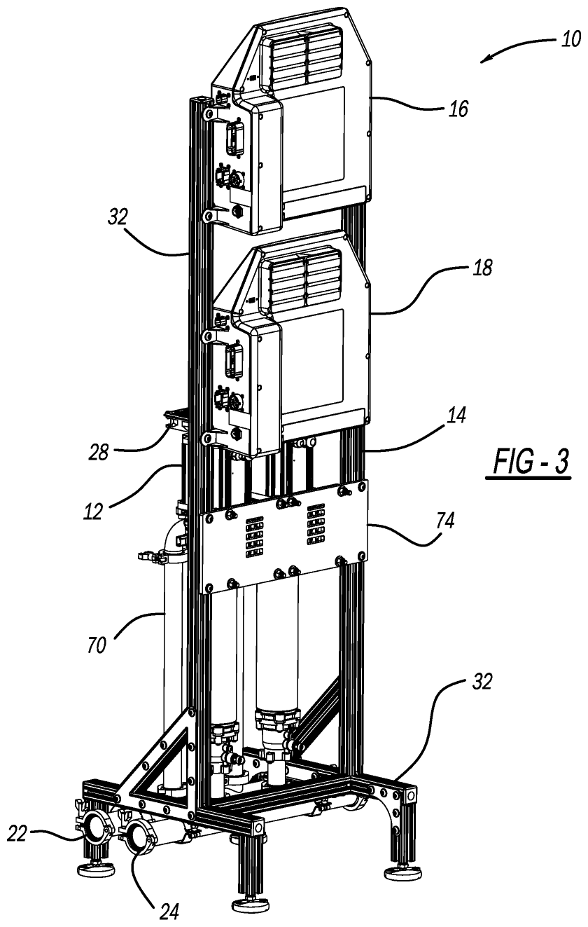

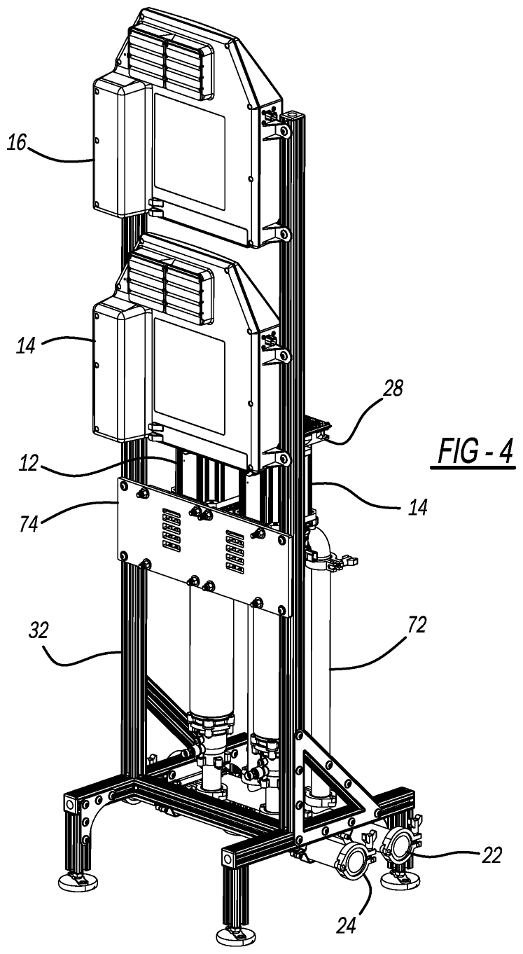

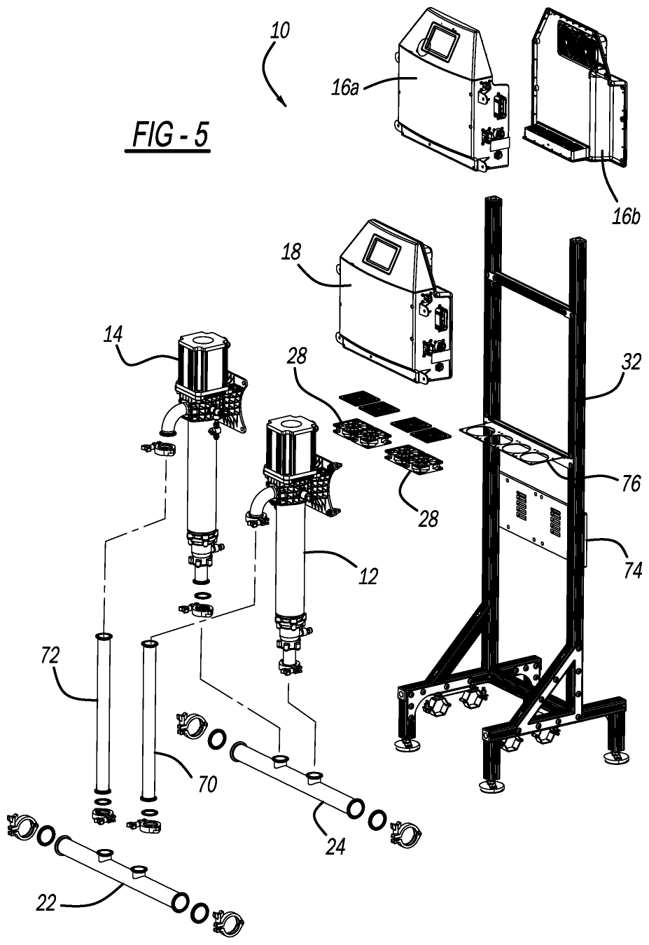

FIGS. 1 and 2 show two views of the front of an example of a pumping system 10 according to the disclosure. FIGS. 3 and 4 show two views of the back of the system. FIG. 5 shows an exploded view of an example of a pumping system. In this example, the pumping system is about 26 inches wide by 21 inches deep by 54 inches tall.

In this example, system 10 includes first and second pump assemblies 12,14, and first and second control panels 16,18, In the example shown in FIGS. 1-5, the two pump assemblies are connected in parallel. In this example, each of the control panels includes touch screen 17. Water source inlet 22 is shown as well as outlet 24. These and other components are fastened to stand 32. In the views shown in FIGS. 1-5, pump assemblies 12,14 are mounted approximately vertical with the pump motors 13 positioned above the pump outlets 15. In other examples, as shown for example, in FIGS. 1447, the pumps may be mounted horizontally. In the example of FIGS. 1-5, source inlet 22 and outlet 24 are positioned close to the bottom of the system, and approximately horizontal, parallel to the ground. This positioning of source inlet 22 and outlet 24 allows two or pumping systems to be fluidly connected more easily by connecting the inlets and outlets of adjacently positioned systems.

In other examples, there may be more than one inlet and more than one outlet. For example, each pump assembly may receive source water through separate inlets. In other examples, water outputted by the pump assemblies may flow through separate outlets.

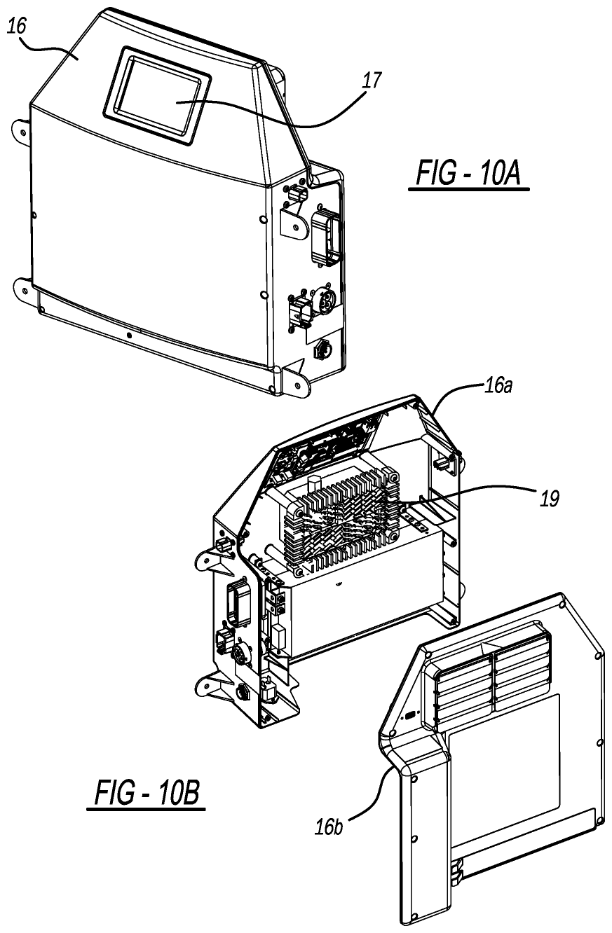

In this example, there are two control panels 16, 18 one for each pump assembly, where the control panels are placed one above the other, forming a pumping system with a compact profile. The control panels are positioned above the pump assemblies in this example. The exploded view of FIG. 5 shows that control panel 16 is assembled from two halves 16a, 16h. In other examples, a pumping system have a single control panel with two touch screens, one touch screen for each pump assembly. FIG. 10a and 10b also shows front and rear views of a controller with FIG. 10b showing the two halves 16a, 16b of a control panel with controller 19 also shown.

In this example, feed tubes 70,72 extend vertically from source inlet 22 and bend at the top, where one feed tube fluidly connects with each of pump assemblies 12, 14. Fans 28 are also shown, in this example, positioned adjacent to pump motors. For example, operation of pump motors may generate heat which are dispersed by fans 28.

According to the example shown in FIGS. 1-5, source water enters inlet 22 and flows through feed tubes 70, 72 to pump assemblies 12, 14. Water is pumped by the assemblies to pump outlets 15 which are fluidly connected to outlet 24, where the water may then be flowed for use in a desired application or for storage. In preferred examples, the system of FIG. 1 has an output of up to 40 gallons per minute (GPM) at a pressure of 50 pounds per square inch. In preferred examples, pumping systems of the disclosure have an output of from about one to 40 GPM, from about 5 to 40 GPM or from about 10 to 40 GPM, depending on requirements. The maximum water pressure tolerated by this system is about 200 psi.

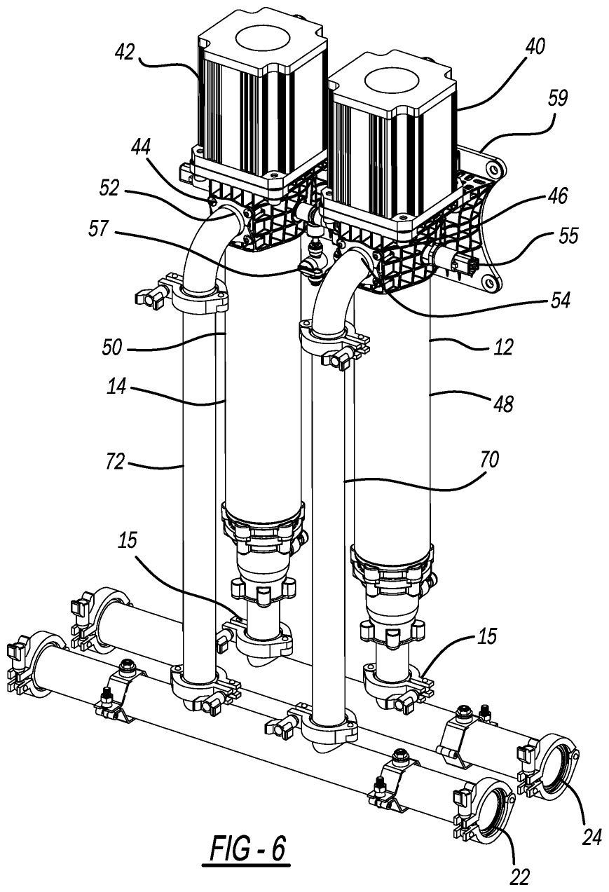

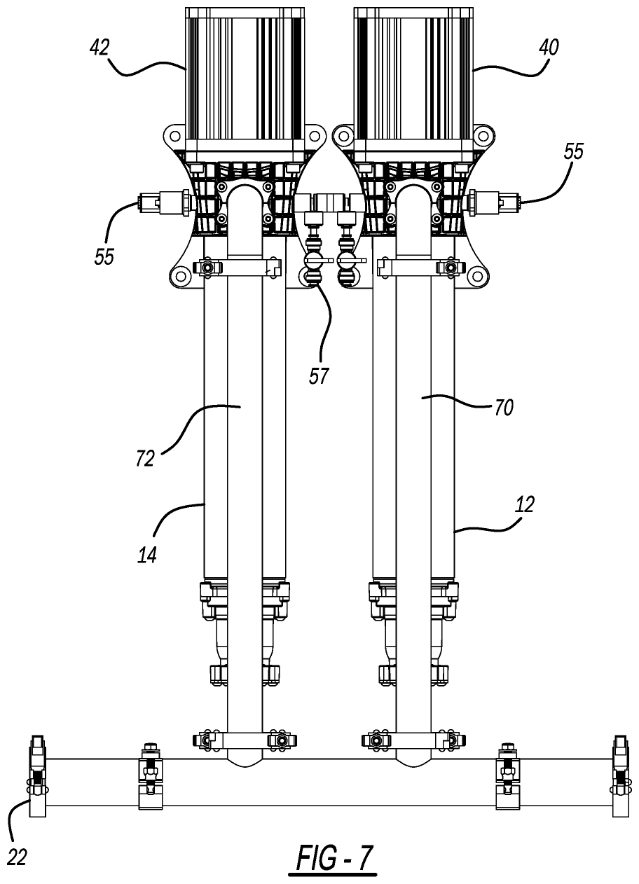

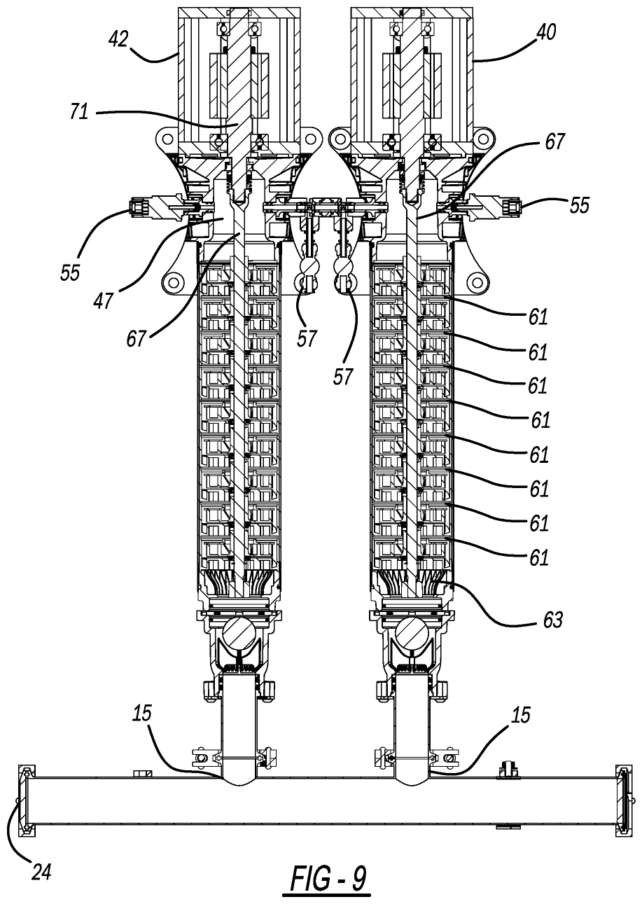

FIGS. 6-9 show enlarged views of pump assemblies according to the disclosure to illustrate certain features of the assemblies. Pump assemblies 12,14 include motors 40, 42, mixing components, 44,46 and impeller components 48, 50. In this example, the impeller is cylindrical, extending from a first end connected to the mixing component to a terminal end having pump outlet 15,where the pump outlet is fluidly connected to outlet 24. Mixing components 44,46 includes ports 52,54 where water from feed tubes 70,72 flows into the pump assemblies. In preferred examples, the motor is a DC motor, such as a 3 horsepower 48 Volt DC motor. In this example, bleed valves 57 are inserted into a port on the mixing component. Pressure gauge 55 is also inserted into a port on the pump assembly, to monitor the water pressure in the assembly. If the water pressure is excessive, then the controller will shut down the system.

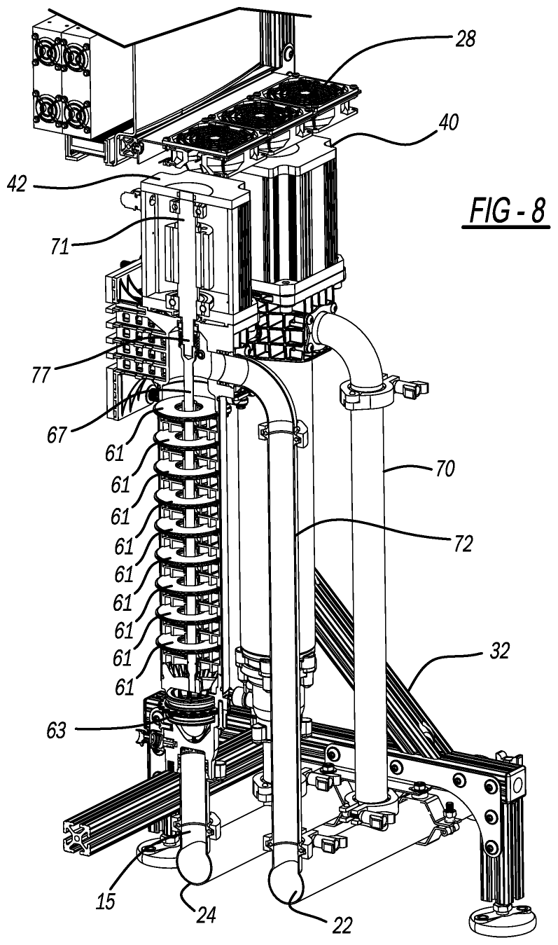

FIG. 8 shows two pump assemblies where the interior of one pump assembly 14 is shown. In this example, feed tube 72 is shown fluidly connected to mixing bowl interior 47. Motor drive shaft 71 is shown engaging with impeller drive shaft 67 in the mixing bowl interior 47 at point 77. Motor drive shaft 71 rotates impeller drive shaft 67 due to the engagement of the two shafts.

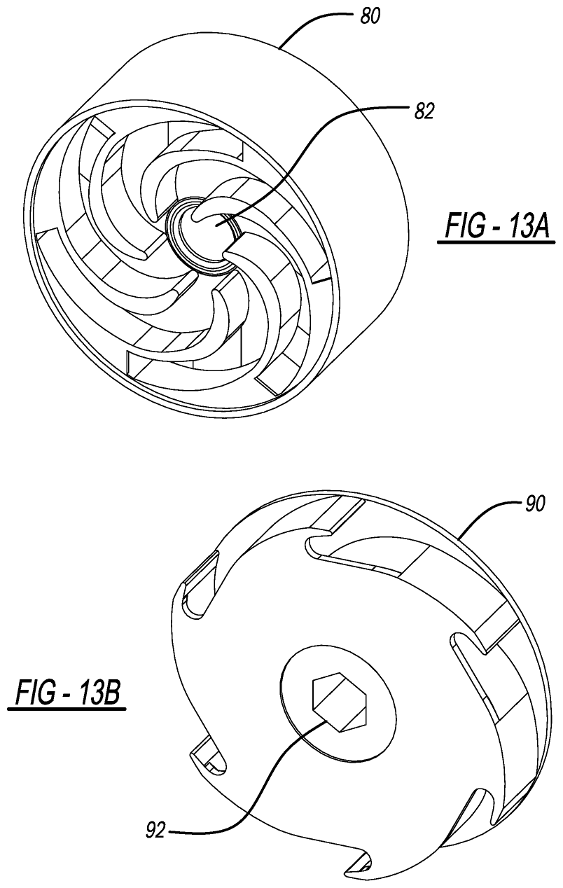

According to preferred examples, source water is fed into mixing bowl interior 47 through feed tube 72 and the rotating impeller drive shaft forces water through each impeller stage to increase flow rate. In this example; the impeller component consists of nine stages 61 that are connected to the impeller drive shaft 67. FIGS. 13a and 13b shows one example of components of an impeller stage including impeller 80 and cassette vane 90, where the two structures fit together. Both structures include orifices 82, 92 through which impeller shaft 67 passes. The impeller 80 and cassette vane 90 are configured to increase the pressure of water flowing through the pump assemblies.

Check valve 63 is present at the terminal end of the impeller component to prevent backflow of water into the impeller component.

The pump assembly may be formed from suitable materials for a particular use. For example, the pump assembly may be formed from stainless steel, but the mixing component may be formed from high density plastic.

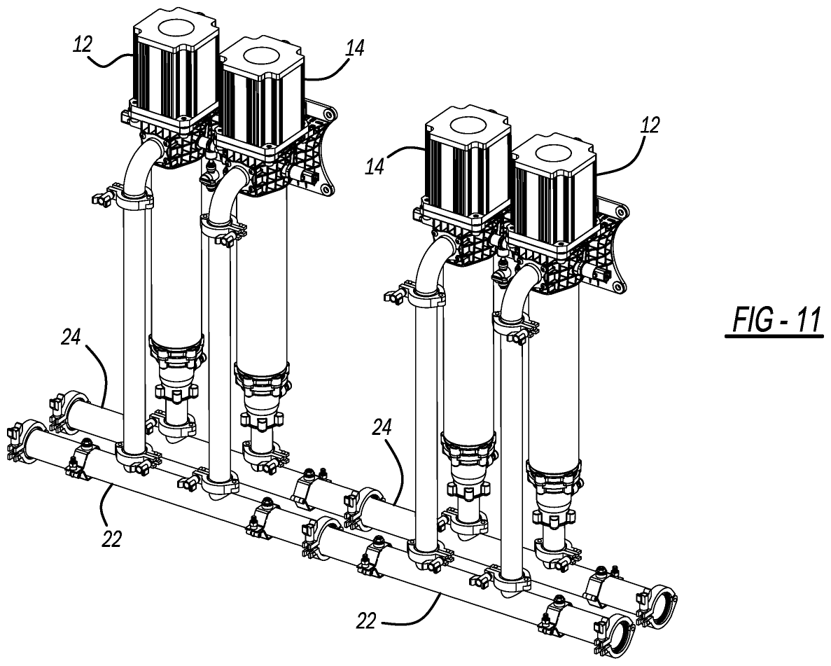

FIG. 11 illustrates the linkage of two pumping systems where the two systems are fluidly connected. In this figure only the linked pump assemblies 12, 14 are shown for clarity. The pumping systems are fluidly connected by linking the respective source inlets 22 and outlets 24.

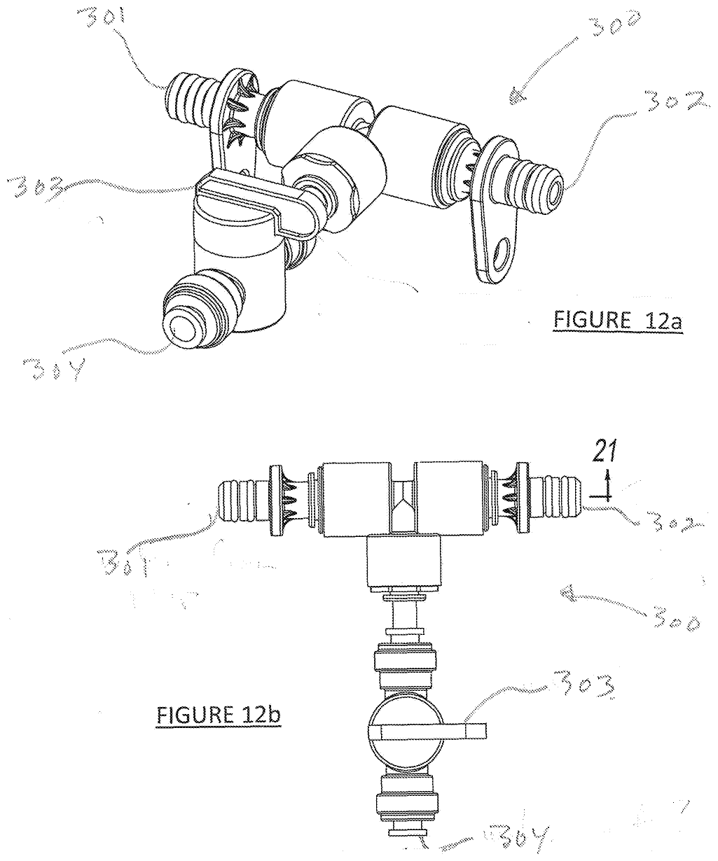

FIG. 12a and FIG. 12b illustrate one example of a bleed valve that may be used with pumping systems of the disclosure. Bleed valve 300 includes orifices 301 and 302, where these orifices are fluidly connected to the mixing bowl of pump assemblies. Valve 303 may be a manual valve or an electronic valve. In the event water pressure exceeds a selected value, the system may be shut down and water bled off by opening valve 303 and allowing water to flow through orifice 304.

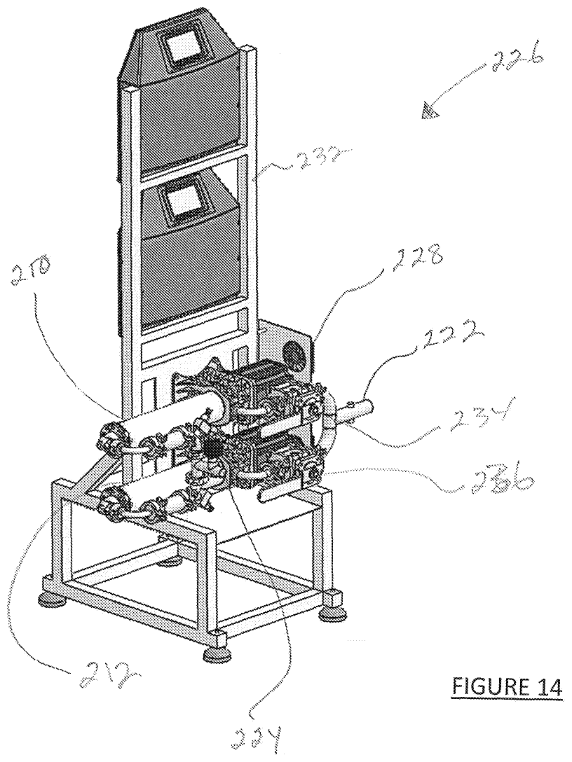

FIG. 14 shows a further example of a pumping system according to the disclosure. In this example, pump assemblies are positioned horizontally, approximately parallel to the ground. The pump assemblies in this example are similar to the pump assemblies previously described, System 226 includes two pump assemblies 210, 212, and two control panels 214, 216. Water inlet 222 is shown as well as outlet 224. Fans 228 are also shown. The components are mounted on stand 232. In this example, one pump assembly 210 is stacked on top of a second pump assembly 212. This mounting orientation allows easy access to inlet 222. In this example, the pump assemblies are connected in parallel. This example shows two manual shut-off valves 234,236 controlling water flow to the pump assemblies. In other examples, water flow to each pump may be regulated using a valve that is controlled electronically, such as a solenoid valve.

In this example, water enters through inlet 222 which splits into two pipes 223, 225 where each pipe enters the mixing component of each pump assembly. After passage through the pump assemblies, water from each assembly is collected at outlet 224.

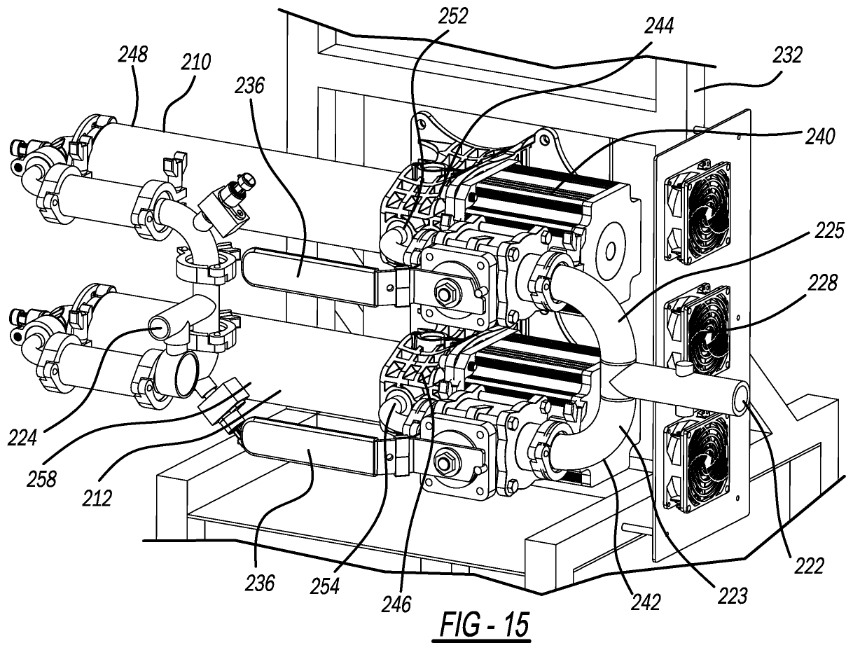

FIG. 15 shows an enlarged view of a system of FIG. 14 to illustrate certain features of the pump assembly and piping. Pump assemblies 210, 212 include motors 240,242, mixing components, 244,246 and impeller components 248, 250. Mixing components 244,246 includes ports 252,254 where water from a source flows into a pump assembly through one or more ports. Inlet and outlet 222, 224 are also shown, Fans 228 are also shown, as well as manual valve shut offs 234,236. Ports 252,254 are shown in FIG. 15, where water flows into mixing components 244,246 through the ports.

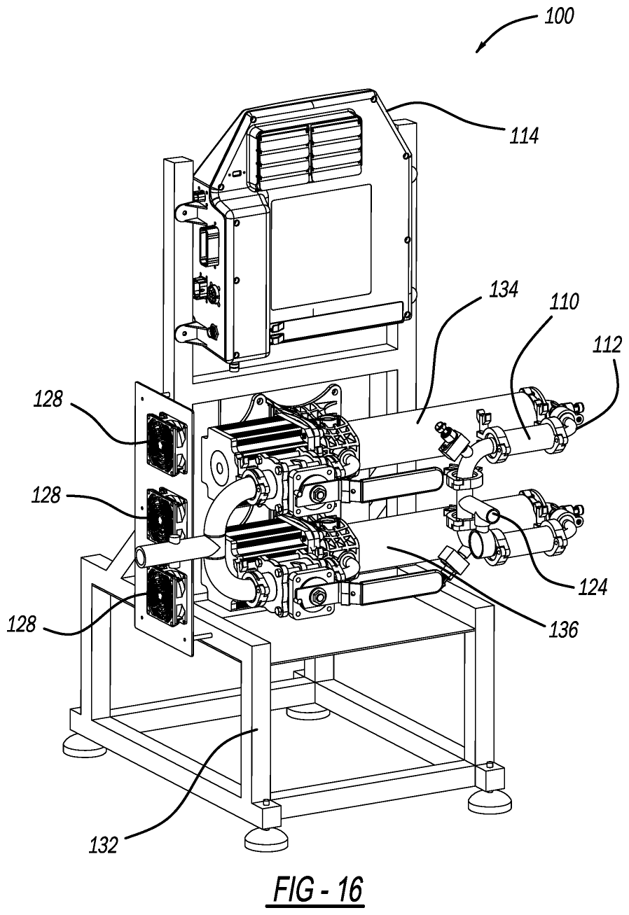

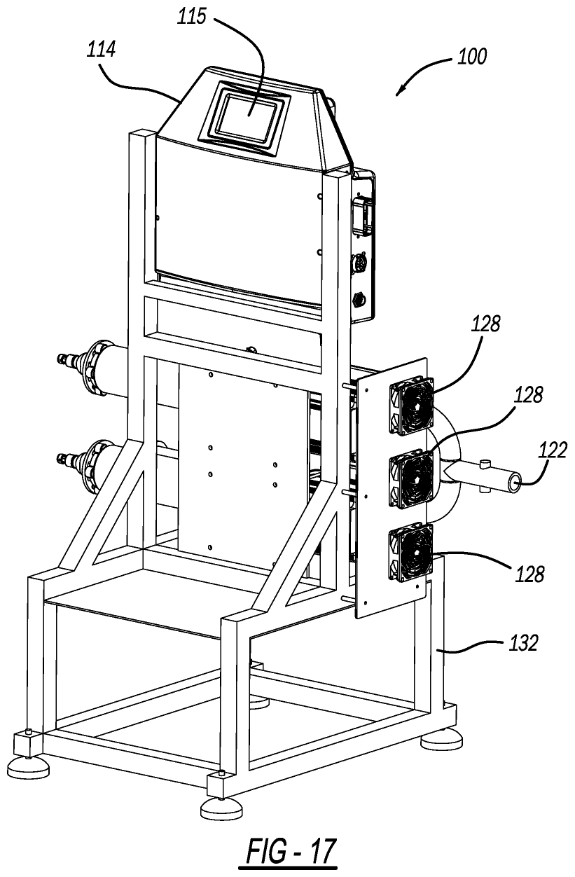

FIGS. 16 and 17 show another example of a pumping system according to the disclosure. In this example, pumping system 100 has a single control panel 114 with screen 115. Fans 128 are shown placed on stand 132. Pump assemblies 110 and 112 mounted horizontally with inlet 122 and outlet 124. Manual shut-off valves 134 and 136 are shown. In this example, pump assemblies may be mounted on either side of the stand on platforms to increase the output of a pumping system.

1. A pumping system, comprising:
at least two pump assemblies;
at least one water inlet
at least one water outlet;
at least one stand;
at least one controller;
said at least one controller independently regulating flow parameters of water inputted and outputted from each of said at least two pump assemblies.

2. The pumping system of claim 1, wherein said at least two pump assemblies are mounted on said stand and said at least two pump assemblies are vertically oriented, wherein water flows down the length of said at least two pump assemblies.

3. The pumping system of claim 1, wherein said inlet and said outlet are mounted on said stand and are horizontally orientated.

4. The pumping system of claim 1, wherein said inlet and said outlet are positioned to allow two pumping systems to be fluidly connected.

5. The pumping system of claim 1, wherein said at least two pump assemblies are mounted on said stand and are horizontally oriented, wherein water flows the length of said at least two pump assemblies.

6. The pumping system of claim 1, wherein each pump assembly comprises a motor, a mixing component and an impeller component.

7. The pumping system of claim 6, wherein said motor is a DC motor.

8. The pumping system of claim 6, wherein said impeller component comprises at least seven stages.

9. The pumping system of claim 6, wherein said impeller component comprises nine stages.

10. The pumping system of claim 6, further comprising a check valve placed at the terminal end of said impeller component.

11. The pumping system of claim 6, wherein said controller controls the speed of said motor.

12. The pumping system of claim 1, wherein said pumping system has an outputted flow rate of from about 1 GPM to about 40 GPM.

13. The pumping system of claim 1, wherein feed tubes fluidly connect said outlet to each of said at least two pump assemblies.

14. The pumping system of claim 1, wherein said at least two pump assemblies comprise at least one check valve.

15. The pumping system of claim 1, wherein said pumping system is fluidly connected to a second pumping system by connecting said inlets and said outlets of said pumping system and said second pumping system.
